(19) United States
(12) Patent Application Publication
(10) Pub. No.: US 2011/0246600 A1
(43) Pub. Date: Oct. 6, 2011

(54) MEMORY SHARING APPARATUS

(75) Inventors: Yoshiteru KAGEYAMA, Matsudo-shi (JP); Kazuhiro Kawagome, Tokyo (JP); Tetsuo Hasegawa, Tokyo (JP)

(73) Assignee: KABUSHIKI KAISHA TOSHIBA, Tokyo (JP)

(21) Appl. No.: 13/077,021

(22) Filed: Mar. 31, 2011

(30) Foreign Application Priority Data
Apr. 1, 2010 (JP) 2010-085341

(51) Int. Cl. G06F 15/167

(52) U.S. Cl. 709/213

(57) ABSTRACT

A memory sharing apparatus includes a server, a host and a client. The server includes a shared page which is an entity of a shared memory, a share setting page which is data in which an index value of each shared page is collected, and a grant table in which a page frame number of each share setting page and the index value are stored so as to correspond to each other. The host includes a database in which the index value in the grant table is managed. The client includes the shared page and a shared page area to which the shared page is mapped, and a share setting page area to which the share setting page is mapped.

### CROSS REFERENCE TO RELATED APPLICATIONS

This application is based upon and claims the benefit of priority from prior Japanese Patent Application No. 2010-85341, filed on Apr. 1, 2010, the entire contents of which are incorporated herein by reference.

### FIELD

An embodiment of the present invention relates to a memory sharing apparatus.

### BACKGROUND

There is an apparatus for connecting two machines via a shared memory HW, physically blocking an IP network, and thereby blocking IP packets which are not desired to be passed (referred to as “IP packet blocking apparatus”). However, there is a need to more inexpensively perform data transmission and reception at higher speed. In order to address this need, an IP packet blocking apparatus has been proposed in which OSs running on two machines required for the IP packet blocking apparatus are virtualized, and the two virtualized OSs are physically caused to run on one machine to enable data transmission and reception between the two virtualized OSs.

As one of such conventional arts, a resource assignment system, a resource assignment method and a program thereof have been proposed (for example, JP-A 2009-169672(Kokai)). This technique is summarized as follows. An arbitration program for resource assignment for a memory or the like is previously embedded in a VMM (Virtual Machine Monitor). When a resource assignment request is issued from a service on a guest OS, an amount of resource to be assigned is determined according to a load on the VMM (a used amount/usage rate of the resource).

Moreover, as another technique for performing the data transmission and reception between the virtualized OSs at high speed, a system and a method for host-to-host communication have been proposed (for example, JP-A 2007-193812(Kokai)). This technique is a technique for causing a plurality of OSs running within one system to communicate with each other, and needs to include a gateway for the host-to-host communication to cause the plurality of OSs to communicate with each other.

In order to realize the IP packet blocking apparatuses as described above, the OS virtualization and memory sharing are performed on a virtualized environment Xen (Xen: software for realizing a virtual machine environment). It is premised that no network connection exists between the virtualized OSs (guest OSs). This is for maintaining security, and thus a section for waiting for a request cannot be created.

The above conventional method has a problem of cumbersome management of a page area desired to be shared. FIG. 10 is a diagram showing a conventional process for managing the page area between the guest OSs without any network connection between them.

A commonly used conventional method provides a virtualized host OS, a virtualized guest OS (server), and a virtualized guest OS (client) on a hypervisor (VMM). The virtualized guest OS (server) has a real memory area desired to be shared between the guest OSs, a grant table and a server application. Moreover, the virtualized guest OS (client) has a map area, a grant table and a client application. It should be noted that meanings of these “grant table”, “host OS”, “guest OS”, “server” and “client” will be described later.

In the commonly used conventional method shown in FIG. 10, the following process needs to be performed for sharing a real memory area of one page between the guest OSs.

(1) The server application obtains a frame number of the page of the real memory area desired to be shared.

(2) The server application registers the obtained frame number into the grant table, and obtains an index value corresponding to the frame number.

(3) The server application registers the obtained index value into a database managed by the virtualized host OS.

(4) The client application of the guest OS (client) with which the page is shared obtains the index value from the database.

(5) Following the above (4), the client application issues a map request to the hypervisor.

(6) In response to the above map request, the hypervisor performs a map process for the grant table on the virtualized guest OS (server) side. Then, the sharing process is completed.

In the above process, the database needs to manage the guest OS for which mapping is permitted, and the index value in the grant table, for each page to be shared. Thus, there is a problem of a cumbersome process required for sharing, and slow processing speed.

Moreover, in the conventional method, there is also a problem that the OS which is a sharer must be hard-coded in the registration of the page area into the grant table, which is not flexible. More particularly, the server previously registers an ID value of the client and the page frame number of the memory to be provided, into the grant table managed by the server itself. On the other hand, the client issues a memory map request by using an ID value of the server and the index value in the grant table. However, there is no easy means for dividing a real memory reserved by the server into portions of any length and providing the divided portions to a plurality of clients. Thus, there is the problem that the OS which is the sharer must be hard-coded, which is not flexible.

It should be noted that the technique disclosed in JP-A 2009-169672 as described above is not an approach for memory assignment between the guest OSs, but is the method of the resource assignment between the host OS (VMM) and the guest OS, and has a main object of preventing the entire system from becoming incapable of providing services even when a heavily-loaded service operates on the guest OS. Consequently, this technique cannot solve the problems in this proposition.

Moreover, in the technique disclosed in JP-A 2007-193812 as described above, hosts do not directly share the memory with each other, and permission for access to memory content managed by a virtual device is obtained through the gateway for the host-to-host communication. This technique does not satisfy a precondition for an object of the present invention that no network connection exists between the virtualized OSs (guest OSs).

The object of the present invention is to create a memory sharing apparatus in which a shared memory is used on a virtualized environment.

### BRIEF DESCRIPTION OF THE DRAWINGS

FIG. 1 is a diagram showing one of data configuration examples of a share setting page;

FIG. 2 is a diagram showing an example of a share setting page creation procedure in a case where a client is limited;

FIG. 3 is a diagram showing an example of the share setting page creation procedure in a case where any client may be set;

FIG. 4 is a diagram showing a data configuration example of an individual setting memory area;

FIG. 5 is a block diagram showing a configuration example of a memory sharing apparatus;

FIG. 6 is a flowchart showing an operation example of the memory sharing apparatus shown in FIG. 5 in the case where the client is limited;

FIG. 7 is a flowchart showing an operation example of the memory sharing apparatus shown in FIG. 5 in the case where any client may be set;

FIG. 8 is a flowchart showing the operation example of the memory sharing apparatus shown in FIG. 5 in the case where any client may be set;

FIG. 9 is a block diagram showing a configuration example of an IP isolation apparatus; and

FIG. 10 is a diagram showing a conventional process for managing a page area between guest OSs without any network connection between them.

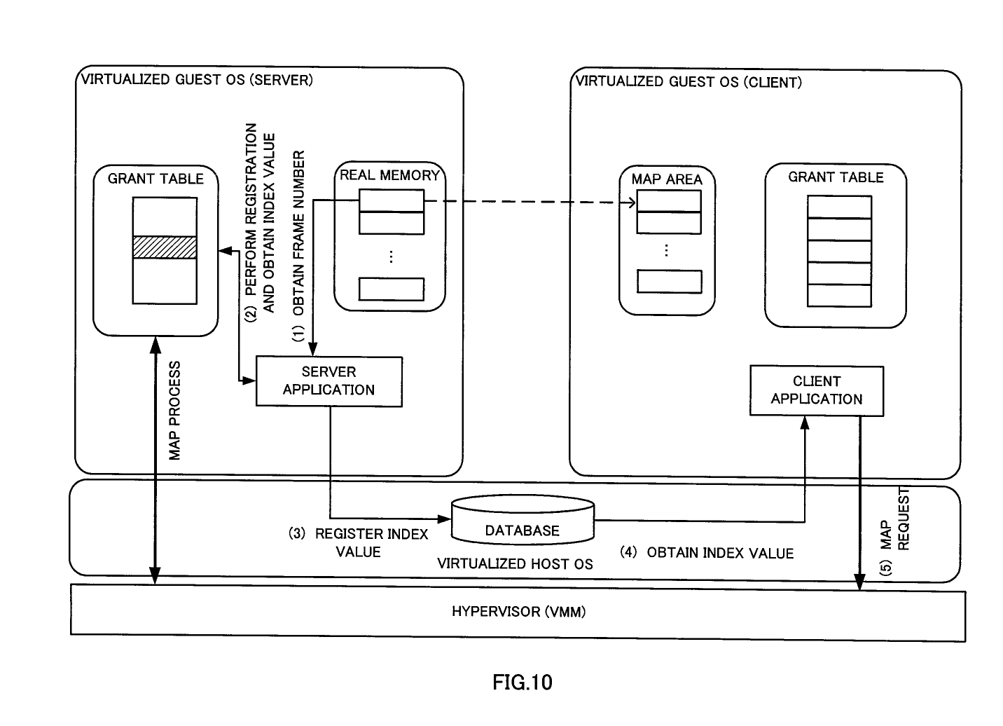

### DETAILED DESCRIPTION

A memory sharing apparatus according to an embodiment of the invention, includes a server, a host and a client. The server includes a shared page which is an entity of a shared memory, a share setting page which is data in which an index value of each shared page is collected, and a grant table in which a page frame number of each share setting page and the index value are stored so as to correspond to each other. The host includes a database in which the index value in the grant table is managed. The client includes the shared page and a shared page area to which the shared page is mapped, and a share setting page area to which the share setting page is mapped.

### DEFINITION OF TERMS IN THE PRESENT SPECIFICATION

### 1. Grant Table

“Grant table” is a function provided on a virtualized environment (VMM), and refers to a table for declaring a page frame number of a real memory area desired to be shared, and an ID value indicating OS (Operating System, hereinafter referred to as “OS”) which is a sharer. The OS which is the sharer must previously know where the above declaration is written in this table.

### 2. Host OS

“Host OS” is an OS running on the virtualized environment, and refers to an OS which manages a running guest OS, devices and the like.

### 3. Guest OS

“Guest OS” is an OS running on the virtualized environment, and refers to an OS for operating general applications.

### 4. Server

“Server” refers to a guest OS which reserves the real memory area desired to be shared.

### 5. Client

“Client” refers to a guest OS which maps the memory area desired to be shared, to its own virtual address space.

### 1. MAJOR COMPONENTS OF THE PRESENT INVENTION

First, major components of the memory sharing apparatus which is an embodiment of the present invention will be described.

[1.1. Share Setting Page]

One of the characteristics of an embodiment of the present invention is to have the share setting page. “Share setting page” is a mechanism (information) for sharing information related to the reserved real memory (page). Usage of the share setting page can minimize management of a page area desired to be shared, on the host OS.

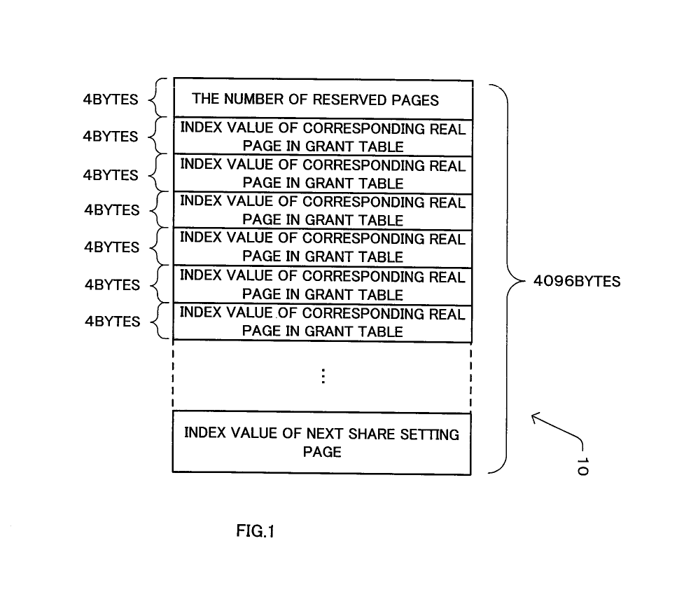

FIG. 1 is a diagram showing one of data configuration examples of the share setting page. In this example, a share setting page 10 includes data of one page (having a length of 4096 bytes). The number of reserved pages is stored in first four bytes. Subsequently, the index value of the corresponding real page in the grant table is stored in each four bytes. If mapping from the guest OS has not yet been performed, initial values are stored. If there is a next share setting page, the index value of the next share setting page is stored in last four bytes of this page.

The share setting page 10 is created and retained by the server. A procedure for creating this share setting page 10 will be described later. Separate share setting pages 10 are created for respective pairs of the client and the server sharing the memory, and thus each client sees different content. Only the index value for a first page of the share setting page 10 in the grant table is managed in the database on the host OS.

When a map request is issued from the client, a portion of the index value of the share setting page 10 is updated. It should be noted that only the guest OS which has reserved the real memory writes data to the share setting page 10.

[1.2. Share Setting Page Creation Procedure]

Next, the above described procedure for creating the share setting page 10 will be described. It should be noted that the creation procedure will be described separately in cases where the client is limited, and where any client may be set.

[1.2.1. Creation Procedure in Case where Client is Limited]

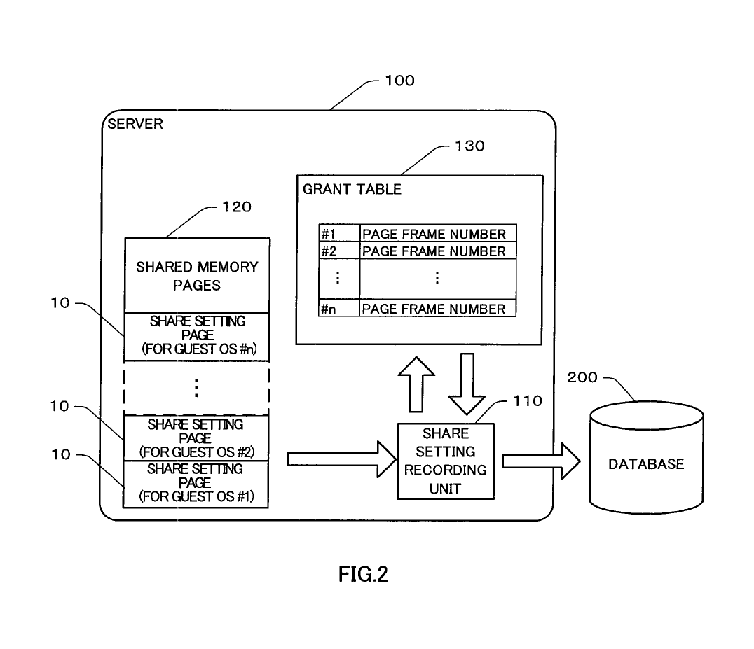

First, the creation procedure in the case where the client is limited will be described. FIG. 2 is a diagram showing an example of the procedure for creating the share setting page 10 in the case where the client is limited.

As described above, the share setting page 10 is created by a server 100. The server 100 has a share setting recording unit 110, shared memory pages 120, a plurality of the share setting pages 10 corresponding to the respective guest OSs, and a grant table 130. It should be noted that the share setting recording unit 110 is connected to a database 200 existing outside of the server 100 so as to be able to write data to the database 200.

The server previously prepares the share setting pages 10 for the clients (guest OSs). Next, the share setting recording unit 110 obtains the page frame number of each share setting page 10, and registers the obtained page frame number into the grant table 130. In the grant table 130, a pair of each page frame number and identification information (ID) of the OS, as well as the index value are stored so as to correspond to each other. Next, the share setting recording unit 110 obtains the index value from the grant table 130, and registers this index value into the database 200 on the host OS. Then, the creation of the share setting page is completed.

[1.2.2. Creation Procedure in Case where any Client May be Set]

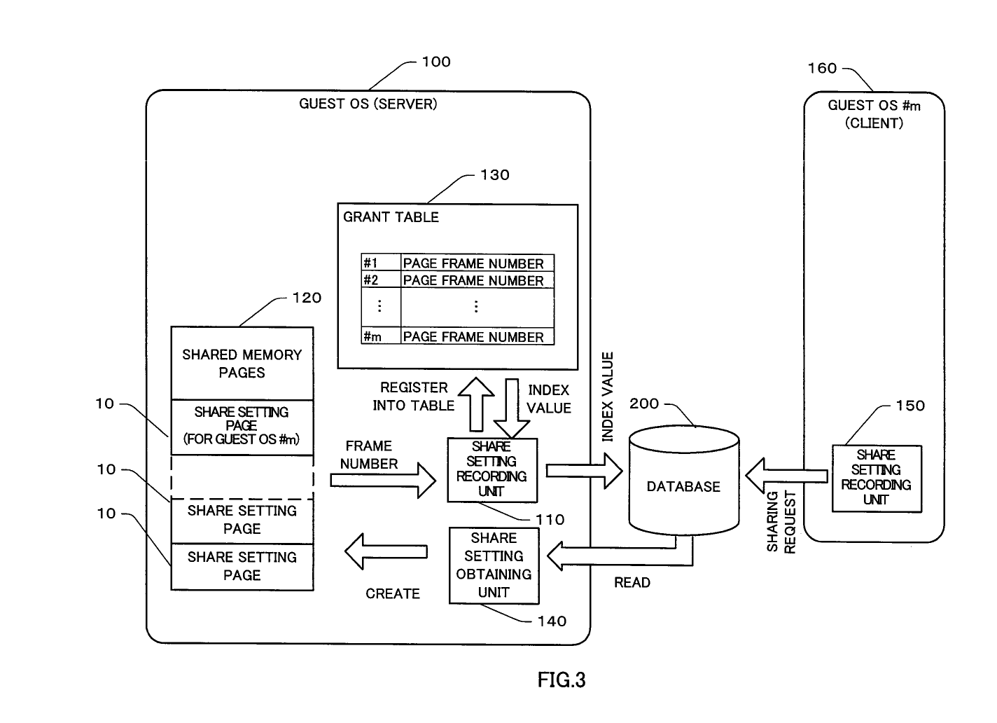

Next, the creation procedure in the case where any client may be set will be described. FIG. 3 is a diagram showing an example of the procedure for creating the share setting page 10 in the case where any client may be set.

Similarly to the above, the share setting page 10 is created by the server 100. The server 100 has the share setting recording unit 110, the shared memory pages 120, the plurality of share setting pages 10 corresponding to the respective guest OSs (clients), the grant table 130, and a share setting obtaining unit 140. It should be noted that the share setting recording unit 110 is connected to the database 200 existing outside of the server 100 so as to be able to write data to the database 200. Moreover, there is a guest OS 160 which is set as the client, and the guest OS 160 has a share setting recording unit 150. The share setting recording unit 150 is connected to the database 200 so as to be able to write data to the database 200.

The share setting recording unit 150 of the guest OS 160 which is the client registers a memory sharing request onto the database.

The share setting obtaining unit 140 of the server 100 periodically monitors the database 200 on the host OS. When reading from the database 200 on the host OS that there has been the sharing request, the share setting obtaining unit 140 of the server 100 dynamically creates the share setting page 10 corresponding to the guest 160.

Next, the share setting recording unit 110 of the server 100 obtains the page frame number of the created share setting page 10, and registers the obtained page frame number into the grant table 130. In the grant table 130, the pair of each page frame number and the identification information (ID) of the OS, as well as the index value are stored so as to correspond to each other. Next, the share setting recording unit 110 of the server 100 obtains the index value from the grant table 130, and registers this index value into the database 200 on the host OS. Then, the creation of the share setting page is completed.

[1.2. Individual Setting Memory Area]

In addition to the above usage of the share setting page 10, the present invention may further include an individual setting memory area as a characteristic.

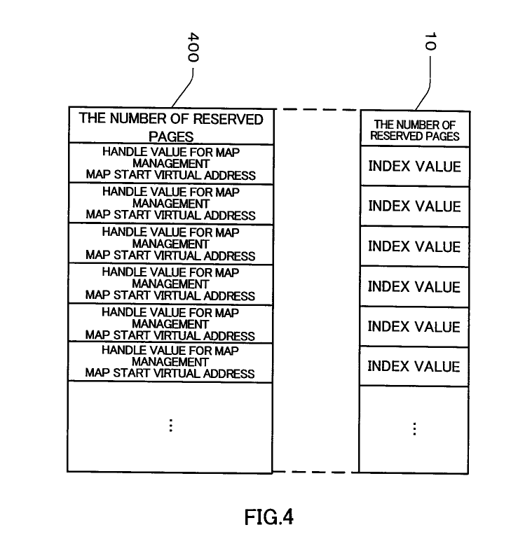

The individual setting memory area is information for managing the mapped memory (page) which is managed by each client. FIG. 4 shows a data configuration example of the individual setting memory area. As shown in FIG. 4, an individual setting memory area 400 is configured to have a one-to-one correspondence relationship with the share setting page 10. The individual setting memory area 400 includes data of one page (having a length of 4096 bytes). The number of reserved pages is stored in first four bytes. Subsequently, a handle value for map management (used when there is a request to the virtualized environment) and a map start virtual address (used for demapping) are stored in each four bytes. Thereby, even a request for a plurality of shared memories from the same guest OS can be realized, and the OS which is the sharer of the memory can be managed to be flexibly determined.

### 2. CONFIGURATION EXAMPLE OF MEMORY SHARING APPARATUS

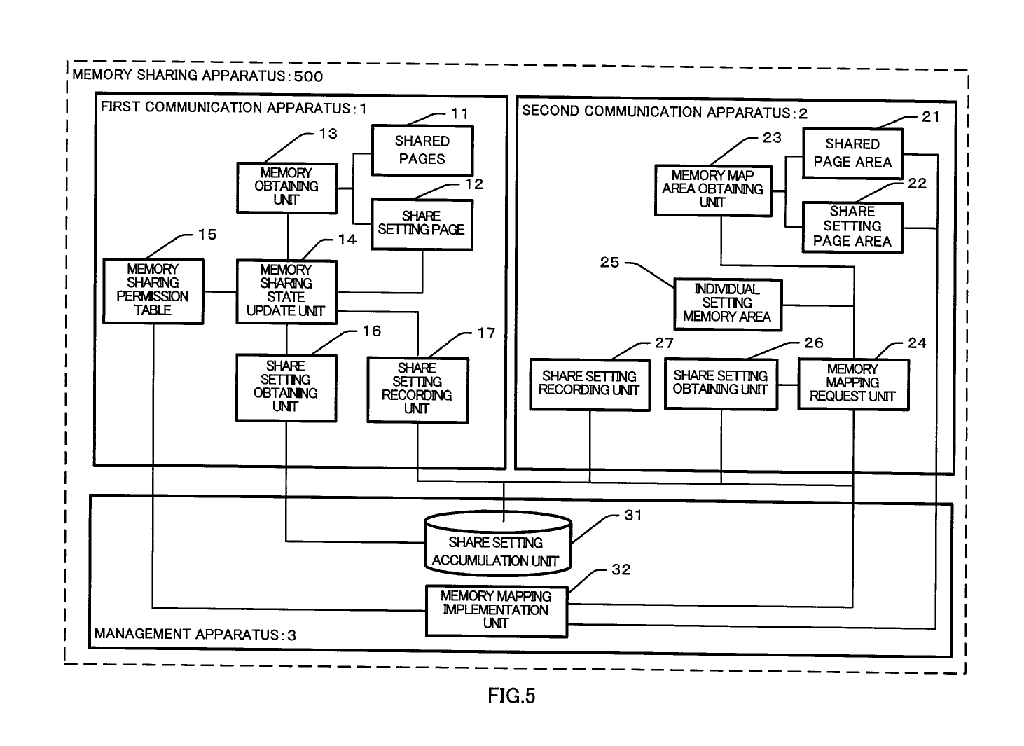

Next, a configuration example of the memory sharing apparatus which is an embodiment of the present invention will be described. FIG. 5 is a block diagram showing the configuration example of the memory sharing apparatus which is an embodiment of the present invention.

The memory sharing apparatus is an apparatus realized by an information processing apparatus, for example, such as a computer or a workstation. This information processing apparatus is an apparatus including a central processing unit (CPU), a main memory (RAM), a read-only memory (ROM), an input/output device (I/O), and an external storage device such as a hard disk device, if necessary. A memory sharing apparatus 500 has a first communication apparatus 1, a second communication apparatus 2, and a management apparatus 3. The first communication apparatus 1 corresponds to the guest OS (server 100). The second communication apparatus 2 corresponds to the guest OS (client 160), and the management apparatus 3 corresponds to the host OS.

Both the first communication apparatus 1 and the second communication apparatus 2 function as apparatuses which transmit and receive data by using a shared memory. There may be a plurality of the first communication apparatuses 1 and a plurality of the second communication apparatuses 2. The first communication apparatus 1 and the second communication apparatus 2 are virtualized so as to operate on the management apparatus 3. The management apparatus 3 is an apparatus which manages resources used by the first communication apparatus 1 and the second communication apparatus 2.

The first communication apparatus 1 and the second communication apparatus 2, as well as the management apparatus 3 may be realized on one information processing apparatus (such as a computer, a workstation or a mobile communication device).

[2.1. First Communication Apparatus]

Next, a configuration of the first communication apparatus 1 will be described. The first communication apparatus 1 has shared pages 11, a share setting page 12, a memory obtaining unit 13, a memory sharing state update unit 14, a memory sharing permission table 15, a share setting obtaining unit 16, and a share setting recording unit 17. It should be noted that the above respective components correspond to functions realized by the CPU, a program, and a storage device such as the memory, and a circuit or a device corresponding to each of these components does not need to be actually included within the information processing apparatus (the same applies to the second communication apparatus 2 and the management apparatus 3).

The memory obtaining unit 13 is connected to the shared pages 11 and the share setting page 12 so as to be able to read them. The memory sharing state update unit 14 is connected to the share setting page 12, the memory obtaining unit 13, the memory sharing permission table 15, the share setting obtaining unit 16, and the share setting recording unit 17. It should be noted that, here, “connected” refers to having a relationship in which data, commands and the like can be exchanged with each other, and is not limited to a physical connection (the same applies to descriptions of the second communication apparatus 2 and the management apparatus 3).

Moreover, the share setting obtaining unit 16 and the share setting recording unit 17 are connected to a share setting accumulation unit 31 to be described later. The memory sharing permission table 15 is connected to a memory mapping implementation unit 32 to be described later.

The above respective components have the following functions, respectively.

The shared pages 11 are an entity of the shared memory used for the data transmission and reception between the first communication apparatus 1 and the second communication apparatus 2, and corresponds to the above described shared memory pages 120.

The share setting page 12 is data in which index values in the memory sharing permission table are collected, and which is required for sharing the shared pages 11 between the first communication apparatus 1 and the second communication apparatus 2, and corresponds to the above described share setting page 10.

The memory obtaining unit 13 operates in the communication apparatus which obtains the real memory, reserves the shared pages 11 and the share setting page 12, and obtains the page frame number corresponding to the shared pages 11 and the share setting page 12.

The memory sharing state update unit 14 registers the page frame number which corresponds to the shared pages 11 and the share setting page 12 and is obtained by the memory obtaining unit 13, as well as an ID value of the second communication apparatus 2 with which sharing is permitted, into the memory sharing permission table 15.

The memory sharing permission table 15 is a table (data) for managing which page in pages within the first communication apparatus 1 is enabled to be shared with which communication apparatus, and corresponds to the above described grant table 130. It should be noted that the memory sharing permission table 15 prepared by the management apparatus 3 is used.

The share setting obtaining unit 16 has a function of periodically obtaining information which is related to the second communication apparatus 2 and registered in the share setting accumulation unit 31 to be described later. The share setting obtaining unit 16 corresponds to the above described share setting obtaining unit 140.

The share setting recording unit 17 has a function of writing the index value for the share setting page 12 in the memory sharing permission table 15, into the share setting accumulation unit 31.

[2.2. Second Communication Apparatus 2]

Next, components of the second communication apparatus 2 will be described. The second communication apparatus 2 has a shared page area 21, a share setting page area 22, a memory map area obtaining unit 23, a memory mapping request unit 24, an individual setting memory area 25, a share setting obtaining unit 26, and a share setting recording unit 27. The memory map area obtaining unit 23 is connected to the shared page area 21 and the share setting page area 22 so as to be able to read them. The memory mapping request unit 24 is connected to the memory map area obtaining unit 23, the individual setting memory area 25, and the share setting obtaining unit 26.

Moreover, the memory mapping request unit 24, the share setting obtaining unit 26, and the share setting recording unit 27 are connected to the share setting accumulation unit 31 to be described later. Moreover, the shared page area 21 and the share setting page area 22 are connected to the memory mapping implementation unit 32 to be described later.

Functions of the above respective components will be described below.

The shared page area 21 and the share setting page area 22 are areas for mapping the shared pages 11 and the share setting page 12 of the first communication apparatus 1 to memory spaces of the second communication apparatus 2, respectively. When a sharing process is completed, the second communication apparatus 2 can read and write the same content as that of the shared pages 11 and the share setting page 12.

The memory map area obtaining unit 23 obtains memory spaces for mapping the shared page area 21 and the share setting page area 22, and obtains virtual addresses of the memory spaces.

The memory mapping request unit 24 has a function of issuing a request for execution of memory mapping, to the memory mapping implementation unit 32.

The individual setting memory area 25 is the information (data) for managing the mapped memory (page) which is managed by each client, as described in the above section of [1.2. Individual Setting Memory Area]. When the shared pages 11 has been successfully mapped to the shared page area 21 by the memory mapping request unit 24, the individual setting memory area 25 records the virtual address thereof and the like.

The share setting obtaining unit 26 (corresponding to a second share setting obtaining unit of the present invention) has a function of reading data in the share setting accumulation unit 31.

The share setting recording unit 27 (corresponding to a share setting recording unit of the present invention) has a function of writing the information related to the second communication apparatus 2, into the share setting accumulation unit 31.

[2.3. Management Apparatus 3]

Next, components of the management apparatus 3 will be described. The management apparatus 3 has the share setting accumulation unit 31 and the memory mapping implementation unit 32.

The share setting accumulation unit 31 has a function of accumulating the index value for the share setting page 12 in the memory sharing permission table 15, and the like, and corresponds to the above described database 200.

The memory mapping implementation unit 32 has a function of actually performing the memory mapping between the first communication apparatus 1 and the second communication apparatus 2, and is provided by a virtualized environment of the management apparatus 3.

### 3. OPERATION EXAMPLE OF MEMORY SHARING APPARATUS

Next, an operation example of the memory sharing apparatus having the above described configuration will be described.

[3.1. Creation Procedure in Case where Client is Limited]

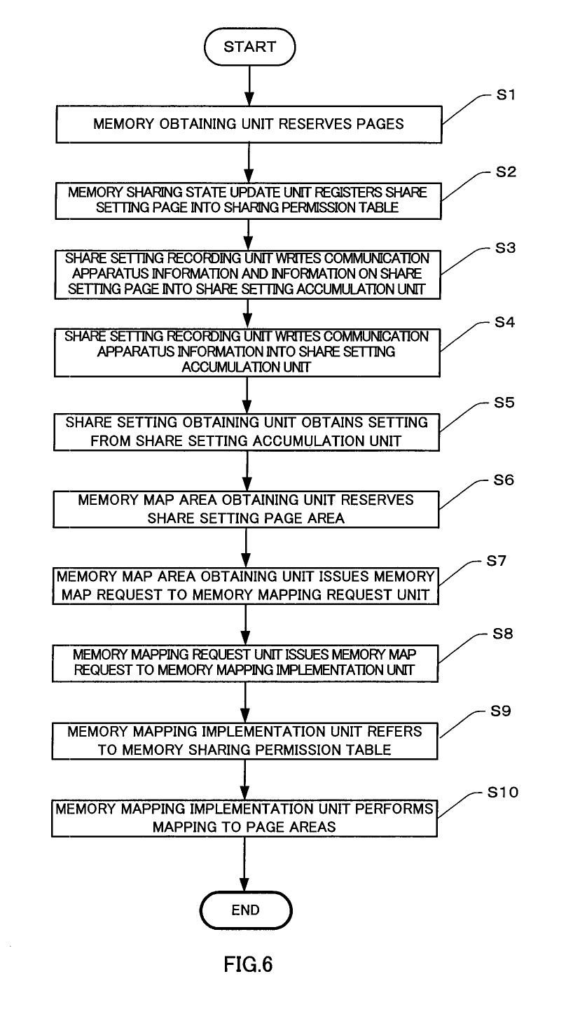

FIG. 6 is a flowchart showing an operation example of the memory sharing apparatus shown in FIG. 5 in the case where the client is limited. Hereinafter, the operation example of the memory sharing apparatus in the case where the client is limited will be described with reference to the block diagram of FIG. 5, and FIG. 6.

First, the memory obtaining unit 13 of the first communication apparatus 1 reserves pages for the shared pages 11 and the share setting page 12 on the memory (not shown) (step S1). When the pages are reserved, the memory sharing state update unit 14 registers the share setting page into the memory sharing permission table 15 (step S2). When the registration into the memory sharing permission table 15 is completed, the share setting recording unit 17 writes information on the communication apparatus with which the memory is shared (in this example, the first communication apparatus 1), and information (the index value) on the share setting page, into the share setting accumulation unit 31 of the management apparatus 3 (S3).

Next, the share setting recording unit 27 of the second communication apparatus 2 writes information on the communication apparatus into the share setting accumulation unit 31 of the management apparatus 3 (S4). Next, the share setting obtaining unit 26 of the second communication apparatus 2 obtains the information on the share setting page written from the share setting accumulation unit 31 in step S3 (S5). Next, the memory map area obtaining unit 23 reserves the area for the share setting page area 22 (S6). After the area is reserved, the memory map area obtaining unit 23 issues a memory map request to the memory mapping request unit 24 (S7). When receiving the memory map request, the memory mapping request unit 24 transmits the memory map request to the memory mapping implementation unit 32 (S6).

When receiving the memory map request, the memory mapping implementation unit 32 refers to the memory sharing permission table 15 (S9), and performs the memory mapping to the shared page area 21 and the share setting page area 22, depending on content of the memory sharing permission table 15 (S10). Then, a process for sharing the memory between the first communication apparatus 1 and the second communication apparatus 2 is completed.

[3.2. Operation Example in Case where any Client May be Set]

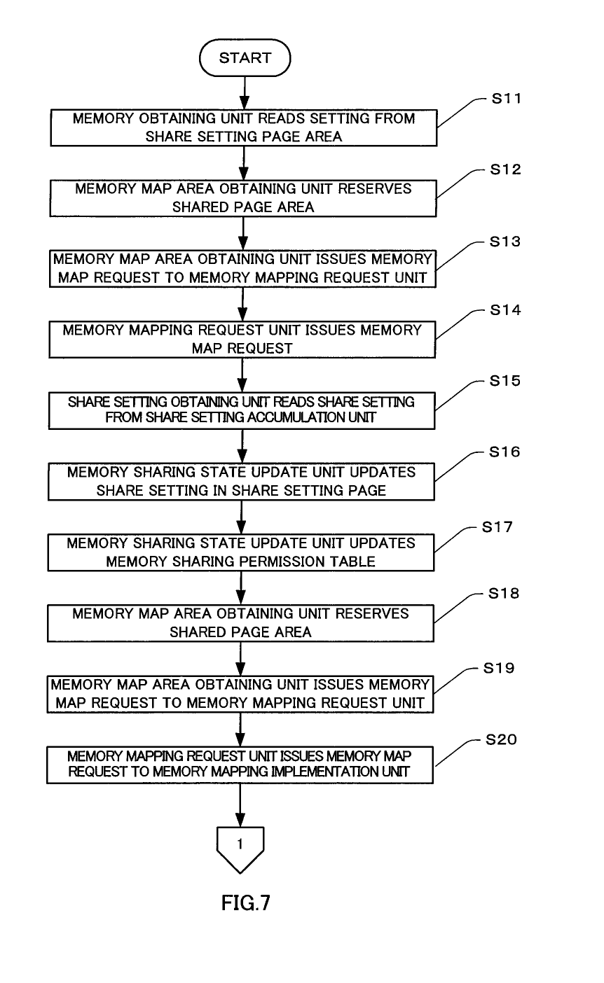

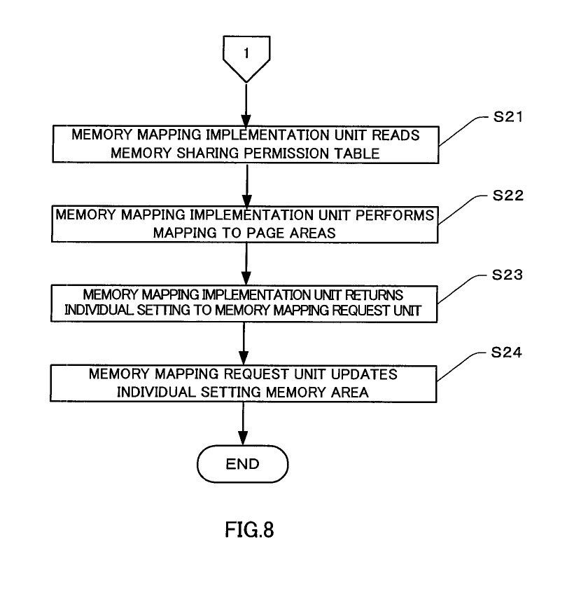

FIGS. 7 and 8 are flowcharts showing an operation example of the memory sharing apparatus shown in FIG. 5 in the case where any client may be set. Hereinafter, the operation example of the memory sharing apparatus in the case where any client may be set will be described with reference to the block diagram of FIG. 5, as well as FIGS. 7 and 8.

First, the memory map area obtaining unit 23 of the second communication apparatus 2 reads setting information from the share setting page area 22 (S11). Next, the memory map area obtaining unit 23 reserves the area for the shared page area 21, depending on the setting information in the share setting page area 22 (S12). Next, the memory map area obtaining unit 23 issues the memory map request to the memory mapping request unit 24 (S13). When receiving the memory map request, the memory mapping request unit 24 transmits the memory map request to the share setting accumulation unit 31 of the management apparatus 3 (S14). The memory map request is registered into the share setting accumulation unit 31.

The share setting obtaining unit 16 of the first communication apparatus 1 periodically monitors the share setting accumulation unit 31 to see if any map request to the first communication apparatus 1 itself has been registered. If the map request to the first communication apparatus 1 itself has been registered, the share setting obtaining unit 16 reads a share setting for this map request, from the share setting accumulation unit 31 (S15). When reading the share setting, the share setting obtaining unit 16 notifies the memory sharing state update unit 14 of the share setting. When receiving the notification, the memory sharing state update unit 14 updates the share setting page 12 (add the corresponding share setting page; S16). Moreover, the memory sharing state update unit 14 updates the memory sharing permission table 15, depending on content of the updated share setting page (add the page frame number and the index value; S17).

Next, the memory map area obtaining unit 23 of the second communication apparatus 2 reads the setting information from the share setting page area 22 (S18). At this time point, the mapping of the shared page area 21 and the share setting page area is not completed. Next, the memory map area obtaining unit 23 issues the memory map request to the memory mapping request unit 24 (S19). When receiving the memory map request, the memory mapping request unit 24 transmits the memory map request to the memory mapping implementation unit 32 of the management apparatus 3 (S20).

When receiving the memory map request, the memory mapping implementation unit 32 refers to the memory sharing permission table 15 (S21), and performs the memory mapping to the shared page area 21 and the share setting page area 22, depending on the content of the memory sharing permission table 15 (S22). Furthermore, the memory mapping implementation unit 32 generates information to be stored in the individual setting memory area (referred to as “individual setting”), depending on the content of the memory sharing permission table 15, and returns this information to the memory mapping request unit 24 (S23). When receiving the individual setting, the memory mapping request unit 24 updates the individual setting memory area 25, depending on content of the individual setting (S24). Thereby, the individual setting memory area corresponding one-to-one to the share setting page 12 is created in the individual setting memory area 25. Then, the process for sharing the memory between the first communication apparatus 1 and the second communication apparatus 2 in the case where any client may be set is completed.

### 4. IP ISOLATION APPARATUS

The memory sharing apparatus according to the present embodiment can also be used as an IP isolation apparatus (an apparatus for disconnecting an IP (Internet Protocol) network and blocking IP packets which are not desired to be passed) using the shared memory in the virtualized environment.

The IP isolation apparatus according to the present embodiment realizes an IP connection between two guest OSs by using the shared memory according to a secure method. Data can be once converted and filtered to be a data packet other than the IP packet between the guest OSs. Moreover, another guest OS which monitors the communication between the two guest OSs to sense unauthorized access may be created.

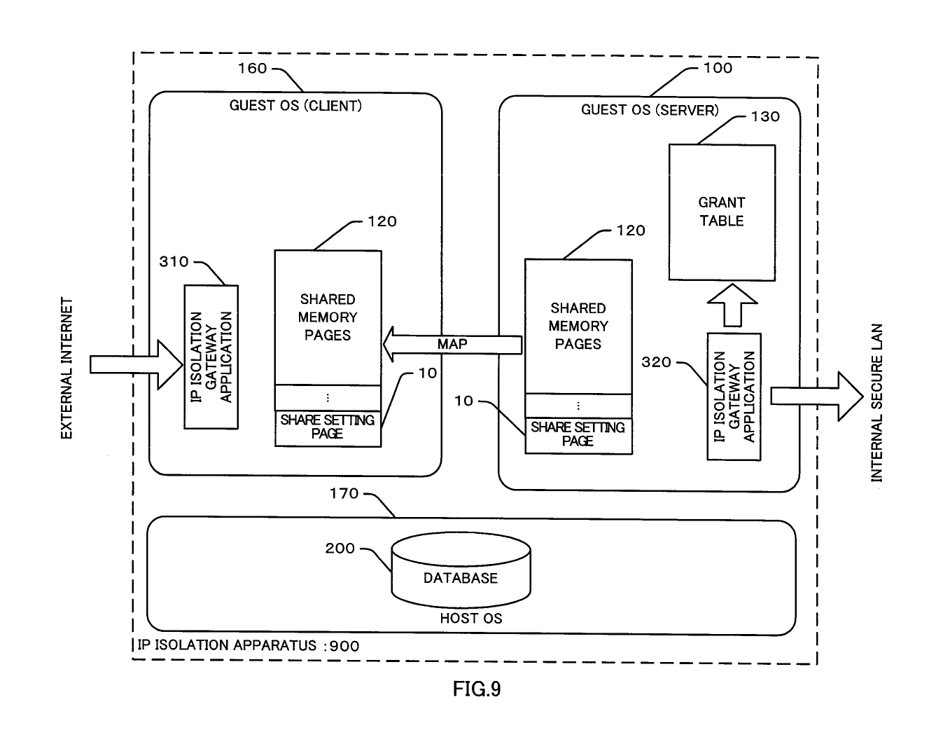

FIG. 9 is a block diagram showing a configuration example of the IP isolation apparatus according to the present embodiment. It should be noted that a basic configuration is similar to the apparatus shown in FIG. 3, and thus the same components are assigned the same reference numerals. The guest OS (server) 100 has a server-side IP isolation gateway application 320, the shared memory pages 120, the plurality of the share setting pages 10 corresponding to the respective guest OSs, and the grant table 130. The server 100 is connected to the database 200 existing outside of the server 100 so as to be able to write data to the database 200. Moreover, there is the guest OS 160 which is set as the client, and the guest OS 160 has a client-side IP isolation gateway application 310, the shared memory pages 120 and the share setting pages 10. A host OS 170 is an OS which manages the guest OSs 100 and 160, and has the database 200.

The server-side IP isolation gateway application 320 is a component corresponding to the memory obtaining unit 13, the memory sharing state update unit 14, the share setting obtaining unit 16, and the share setting recording unit 17 shown in FIG. 5. The server-side IP isolation gateway application 320 is communicably connected to an internal secure LAN. The client-side IP isolation gateway application 310 is a component corresponding to the memory map area obtaining unit 23, the memory mapping request unit 24, the individual setting memory area 25, the share setting obtaining unit 26, and the share setting recording unit 27. The client-side IP isolation gateway application 310 is communicably connected to the external Internet.

The server-side IP isolation gateway application 320 further has a function of, for example, enabling the IP packet except an IP header to be written into the shared memory pages. The client-side IP isolation gateway application 310 can obtain the IP packet as a communication packet without the IP header by referring to content of the shared memory, by a function as the memory sharing apparatus of the present embodiment. Thereby, an IP isolation apparatus 900 which is a form of the present invention enables an inter-network connection between a network such as the internal secure LAN and another network such as the external Internet, without directly communicating a communication packet based on a particular protocol.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### 5. CONCLUSION

According to the present embodiment, management of the page desired to be shared can be minimized because only the page of “first of the share setting page 12” needs to be previously registered into the share setting accumulation unit 31 of the management apparatus 3.

Moreover, according to the present embodiment, even if there are two or more OSs which are the sharers of the memory, the memory can be shared among the respective OSs with a minimum previous arrangement.

In contrast, according to a conventional approach, an ID value indicating the OS which is the sharer of the memory must be previously registered into the grant table. Thus, an amount of the memory to be shared is always hard-coded, which is not flexible.

The above described embodiments are preferable specific examples of the present invention, and thus include technically preferable various limitations. However, of course, the above described embodiments can be combined and changed as appropriate within the scope not deviating from the purport of the present invention.

What is claimed is:

1. A memory sharing apparatus, comprising:
a server including a shared page which is an entity of a shared memory, a share setting page which is data in which an index value of each shared page is collected, and a grant table in which a page frame number of each share setting page and the index value are stored so as to correspond to each other;
a host including a database in which the index value in the grant table is managed; and
a client including a shared page area to which the shared page is mapped, and a share setting page area to which the share setting page is mapped.

2. The apparatus according to claim 1, wherein the client further includes an individual setting memory area for each share setting page, and a handle value for map management and a map start virtual address are stored in the individual setting memory area.

3. A memory sharing apparatus, comprising:
a first communication apparatus including:
a shared page which is an entity of a shared memory;
a share setting page which is data in which an index value of each shared page is collected;
a memory sharing permission table in which a page frame number of each share setting page and the index value are stored so as to correspond to each other;
a memory obtaining unit which reserves the shared page and the share setting page, and obtains the page frame number corresponding to the shared page and the share setting page;
a memory sharing state update unit which registers the page frame number which corresponds to the shared page and the share setting page and is obtained by the memory obtaining unit, as well as an ID value of a second communication apparatus with which sharing is permitted, into the memory sharing permission table; and
a share setting obtaining unit which periodically obtains information which is related to the second communication apparatus and registered in a share setting accumulation unit;
the second communication apparatus including:
a shared page area which is an area for mapping the shared page of the first communication apparatus to a memory space of the second communication apparatus;
a share setting page area which is an area for mapping the share setting page of the first communication apparatus to a memory space of the second communication apparatus;
a memory map area obtaining unit which obtains memory spaces for mapping the shared page area and the share setting page area, and obtains virtual addresses of the memory spaces;
a memory mapping request unit which issues a request for execution of memory mapping;
a second share setting obtaining unit which reads data in the share setting accumulation unit; and
a share setting recording unit which writes the information related to the second communication apparatus, into the share setting accumulation unit; and
a management apparatus including:
the share setting accumulation unit which accumulates the index value for the share setting page in the memory sharing permission table; and
a memory mapping implementation unit which performs the memory mapping between the first communication apparatus and the second communication apparatus.

4. The apparatus according to claim 3, wherein the second communication apparatus further includes an individual setting memory area for each share setting page, and a handle value for map management and a map start virtual address are stored in the individual setting memory area.
